(19) United States
(12) Patent Application Publication
(10) Pub. No.: US 2007/0071024 A1
(43) Pub. Date: Mar. 29, 2007

(54) Method and apparatus for prioritizing access in a communication network

(76) Inventors: Philip A. Schentrup, Hollywood, FL (US); Jean Khawand, Miami, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/233,688

(22) Filed: Sep. 23, 2005

(51) Int. Cl. H04B 7/212

(52) U.S. Cl. 370/443

(57) ABSTRACT

A selective call radio (SCR) (100) is provided for exchanging messages with a base station (150) on inbound and outbound channels. The SCR has a wireless transceiver (102), and a processor (104). The processor is programmed to determine (204) a priority setting for the SCR, and upon detecting an appropriate priority setting, transmit (210 or 214) a resource request message to the base station on a select one of one or more unused transmission slots (162) near in time to a transmission on the outbound channel of control information by the base station.

### FIELD OF THE INVENTION

This invention relates generally to communication system protocols, and more particularly to a method and apparatus for prioritizing access in a communication network.

### BACKGROUND OF THE INVENTION

During emergency periods it is common to experience high congestion in a wireless communication network. A need arises for providing emergency personnel a means for receiving communication priority when attempting to communicate with the communication network under such circumstances.

### SUMMARY OF THE INVENTION

Embodiments in accordance with the invention provide a method and apparatus for prioritizing access in a communication network.

In a first embodiment of the present invention, a selective call radio (SCR) is provided for exchanging messages with a base station on inbound and outbound channels. The SCR has a wireless transceiver, and a processor. The processor can be programmed to determine a priority setting for the SCR, and upon detecting an appropriate priority setting, transmit a resource request message to the base station on a select one of one or more unused transmission slots near in time to a transmission on the outbound channel of control information by the base station.

In a second embodiment of the present invention, an SCR is provided for exchanging messages with a base station on inbound and outbound channels. The SCR operates according to a method having the steps of determining a priority setting for the SCR, and upon detecting an appropriate priority setting, transmitting a resource request message to the base station on a select one of one or more unused transmission slots near in time to a transmission on the outbound channel of control information by the base station.

In a third embodiment of the present invention, a base station is provided for exchanging messages with an SCR on inbound and outbound channels. The base station has a wireless transceiver, and a processor. The processor is programmed to receive a resource request message from an SCR in one or more unused transmission slots in the inbound channel near in time to a transmission on the outbound channel of control information supplied by the base station, determine a priority setting from the resource request message, and upon detecting an appropriate priority setting, transmit a response message to the SCR indicating that service is provided.

### BRIEF DESCRIPTION OF THE DRAWINGS

FIG. 1 is a block diagram of a selective call radio (SCR) in accordance with an embodiment of the present invention.

FIG. 2 is a block diagram of a base station in accordance with an embodiment of the present invention.

FIG. 3 is a block diagram of a protocol for communicating between the SCR and the base station in accordance with an embodiment of the present invention.

FIG. 4 is a flowchart depicting a method operating in the SCR in accordance with an embodiment of the present invention.

FIG. 5 is a flowchart depicting a method operating in the base station in accordance with an embodiment of the present invention.

### DETAILED DESCRIPTION

While the specification concludes with claims defining the features of embodiments of the invention that are regarded as novel, it is believed that the embodiments of the invention will be better understood from a consideration of the following description in conjunction with the figures, in which like reference numerals are carried forward.

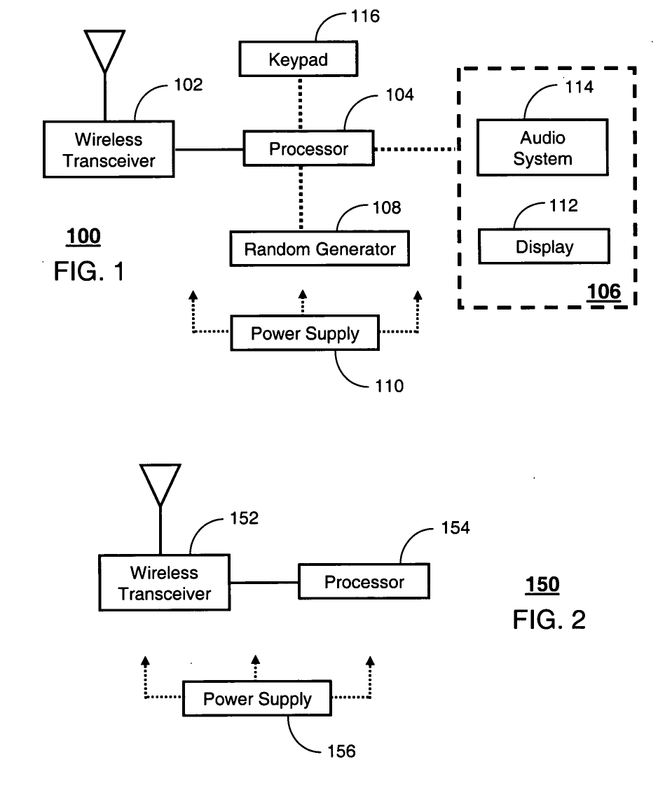

FIG. 1 is a block diagram of a selective call radio (SCR) 100 in accordance with an embodiment of the present invention. The SCR 100 comprises a wireless transceiver 102, and a processor 104 for controlling operations thereof. In a supplemental embodiment, the SCR 100 further includes a user interface 106 having an audio system 114 and display 112, a keypad 116, a random generator 108 and a power supply 110. The wireless transceiver 102 utilizes conventional technology for exchanging wireless messages with a base station 150 (as will be discussed shortly with respect to FIG. 2). The wireless technology can be any conventional wireless technology such as, for example, GSM (Global System for Mobile communication), TDMA (Time Division Multiple Access), or CDMA (Code Division Multiple Access), just to mention a few.

The processor 104 can utilize conventional computing and/or processing technology such as a microprocessor and/or a DSP (Digital Signal Processor). Additionally, the processor 104 can include conventional media such as RAM (Random Access Memory), DRAM (Dynamic RAM), ROM (Read Only Memory), and/or Flash memory for data processing and storage. The audio system 114 utilizes conventional audio technology for intercepting and conveying audible signals to a user of the SCR 100. The display 112 also utilizes conventional technology such as an LCD (Liquid Crystal Display) for conveying images to the user. The keypad 116 is a conventional input device coupled to the processor 104 for intercepting tactile responses from the user. These responses can be, for instance, tactile responses that represent telephone number dialing for accessing another end user. Generally speaking, the keypad 116 serves to control operations of the SCR 100.

The random generator 108 utilizes conventional random generation technology such as pseudo-random counters to randomize a selection as will be described shortly. The power supply 110 utilizes conventional energy conversion technology for supply energy to the aforementioned components of the SCR 100. The power supply 110 can be, for instance, a portable battery-operated supply for portable applications of the SCR 100.

The aforementioned embodiments of the SCR 100 can represent a conventional cellular phone, a wireless PDA (Personal Digital Assistant) and derivatives thereof.

FIG. 2 is a block diagram of a base station 150 in accordance with an embodiment of the present invention. The base station 150 comprises a conventional wireless transceiver 152, a processor 154 for controlling operations thereof, and a power supply 156. The base station 150 exchanges messages with one or more SCRs 100 and can serve to interconnect said SCRs 100 with other SCRs 100 and/or landlines. The wireless transceiver 152 can utilize conventional transceiver technology for long-range communications. To serve a high number of SCRs 100, the processor 154 utilizes conventional computing technology such as a server and/or DSPs with high processing resources (MIPS) coupled to large storage media such as disk drives, and memory modules such as DRAM, and Flash. The power supply 156 can be battery operated and/or can represent a utility company that supplies power to the base station 150.

A number of base stations 150 can be utilized to cover regions (e.g., cells) to provide communication services to a large number of SCRs 100 over a wide geographic area. Such a configuration forms a communication network that is typically managed by a service provider who offers services to public and government consumers.

The aforementioned embodiments of the base station 150 can represent a conventional cellular base station, a wireless access point, and derivatives thereof.

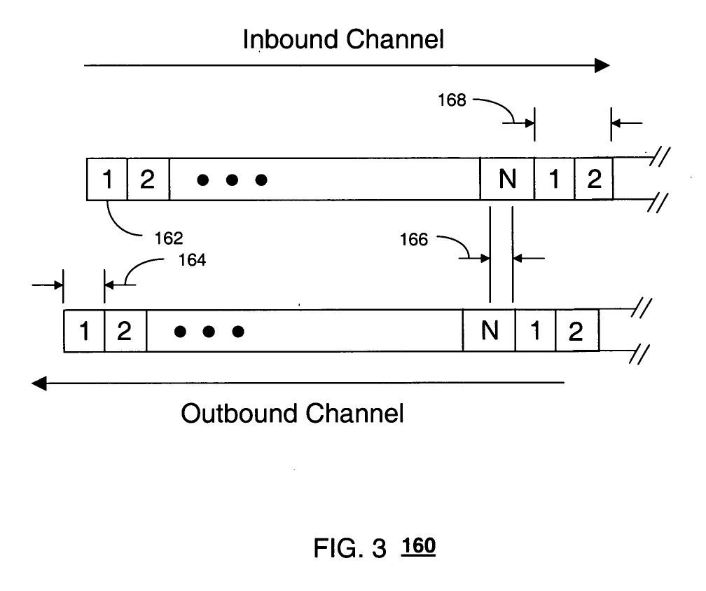

FIG. 3 is a block diagram of a protocol 160 for communicating between the SCR 100 and the base station 150 in accordance with an embodiment of the present invention. The protocol 160 consists of an inbound channel and an outbound channel. The inbound channel is assumed to be the transmission channel of the SCR 100 and the reception channel of the base station 150. Similarly, the outbound channel is assumed to be the transmission channel of the base station 150 and the reception channel of the SCR 100. It would be obvious to an artisan with ordinary skill in the art that this nomenclature can be reversed without affecting the operability of the embodiments of the present invention.

As shown in FIG. 3, each channel comprises a number of time slots 162 (1 through N) in a protocol (or frame structure) 160 which repeat once per frame (i.e., a frame illustrated here to be time slots 1 through N). Each time slot 162 has a duration (e.g., 15 ms) 164 in which either the SCR 100 or the base station 150 can transmit signals. Typically, in conventional transmission systems the inbound and the outbound channels are skewed by a fixed period 166 (e.g., 4 ms). This is in fact the case for legacy wireless TDMA systems.

Generally, the base station 150 selects one or more time slots for communicating control information to the SCRs 100, which in turn instructs the SCRs how to go about selecting time slots 162 of the inbound channel for establishing communications. When control information is transmitted (say on time slot N), the SCRs 100 are programmed to turn on the receiving portion of the wireless transceiver 102 to intercept and decode the control information.

At or near the time when the base station 150 is transmitting the control information, the SCRs 100 disable the transmit portion of the wireless transceiver 102. Accordingly, during control information processing one or more associated time slots 162 on the inbound channel are not utilized by any of the SCRs 100 on the system. Consequently, a portion of the communication bandwidth (see reference 168 of FIG. 3) is relinquished. This unused bandwidth arises at each periodic transmission of control information from the base station 150.

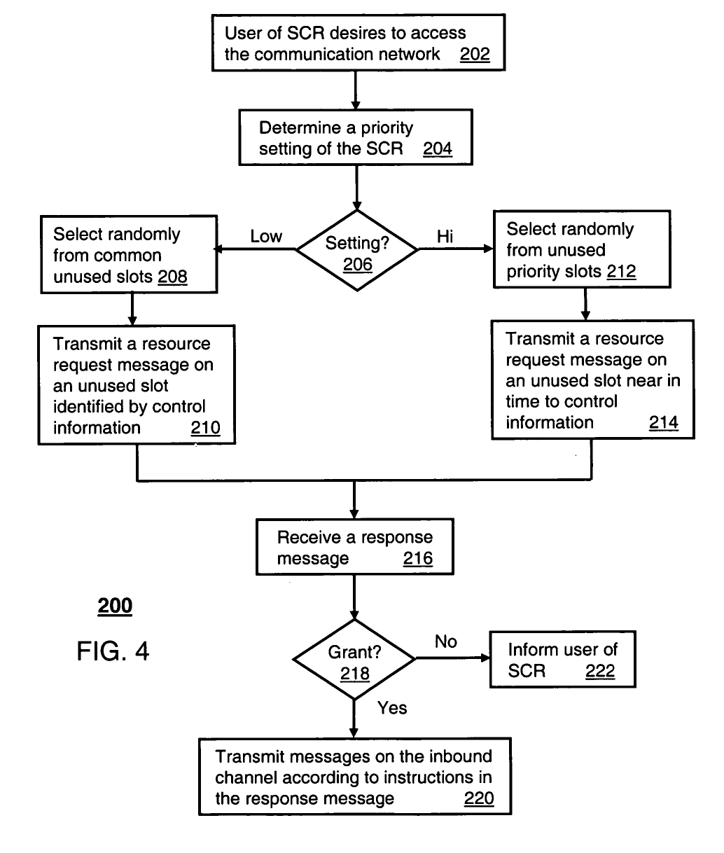

FIG. 4 is a flowchart depicting a method 200 operating in the SCR 100 for making use of the aforementioned unused bandwidth to provide certain SCRs 100 priority access to the communication network in accordance with an embodiment of the present invention. During heavy communication traffic conditions such as might be the case in an emergency, the available time slots 162 for requesting voice and/or data communications can be exhausted, in which case SCRs 100 are unable to establish communication with the base station 150. Method 200 can utilize the aforementioned unused time slots 162 during a transmission of control information by the base station 150 to prioritize communications for particular users of SCRs 100 (e.g., government personnel such as the FBI, CIA, police, fire rescue, and others).

With this in mind, method 200 begins with step 202 where the processor 104 detects a request from the user of the processor 104 indicating the user wants to access the communication network. This step 202 can be represented by the end user dialing a phone number, submitting a text page, and/or a two-way radio dispatch call. In step 204, the processor 104 determines its priority setting. This setting can be stored in the memory of the processor 104, and can be preset and managed, for instance, by the service provider of the communication network. The setting can be as simple as an indication of priority such as high, and low, or more sophisticated prioritization settings such as a numeric listings, or any other prioritization scheme suitable for embodiments in accordance with the present invention.

Assuming a simple prioritization method for illustration purposes only, the processor 104 proceeds from step 206 to step 208 when a low priority is detected, or step 212 when the priority setting is high. In the former case, the processor 104 randomly selects in step 208 from common unused time slots 162 identified by control information provided by the base station 150. The processor 104 then proceeds to step 210 where it transmits a resource request message to the base station 150.

The resource request message indicates the type of message request (e.g., voice or data) and can provide an associated SCR ID, and message length for data transmissions. If the resource request message is received with minimal or no corruption (i.e., nearly no contentious requests), and bandwidth is available, the base station 150 transmits a response message on the outbound channel as an intermixed control channel (i.e., control information overlayed with voice and data traffic), on a common control channel available to all SCRs 100, or on a regular traffic channel (available on an Internet Protocol channel of the communication network) indicating to the SCR 100 where to acquire bandwidth on the inbound channel. The SCR 100 intercepts the response message in step 216. If communication resources are granted in step 218, then the SCR 100 proceeds to step 220 to transmit messages on the inbound channel according to the instructions provided in the response message. If, on the other hand, the request is rejected, the processor 104 proceeds to step 222 where it informs the user of said rejection by way of, for example, the user interface 106. Steps 208, 210, 216, 218, 220, and 222 represent the lowest (or standard) priority for end users to request communication resources from the base station 150.

Upon detecting a high priority setting in step 206, the processor 104 proceeds to steps 212 through 222 where SCRs 100 are provided a higher priority means for requesting from the base station 150 communication bandwidth. In step 212 the processor 104 randomly selects from unused priority time slots 162. These time slots 162 as noted earlier are different from the aforementioned time slots 162 of step 208 in that they occur near in time to a transmission on the outbound channel of control information by the base station 150.

Accordingly, while all other SCRs 100 having a lower priority setting are intercepting the control information from the base station 150 on the outbound channel, the SCRs 100 operating according to steps 212 and 214 transmit a resource request message during a time slot 162 (i.e., priority time slots) unused by the lower priority SCRs 100. The bandwidth available during the time the lower priority SCRs 100 are processing control information on the outbound channel can amount to one or more unused time slots 162 on the inbound channel, which the SCRs 100 executing steps 212 and 214 can use for requesting communication resources from the base station 150.

The combination of random access of these unused slots and the limited population of SCRs 100 having priority to invoke steps 212 and 214 reduces the probability of contention between SCRs 100. Consequently, high priority SCRs 100 have a substantially higher likelihood of communicating with the base station 150 during high traffic conditions than do lower priority SCRs 100.

As before, following a transmission of the resource request message, the processor 104 proceeds to step 216 to process a response message from the base station 150. If communication resources are granted in step 218, the processor 104 proceeds to step 220 to acquire bandwidth on the inbound channel; otherwise, it informs the user that the attempt failed in step 222.

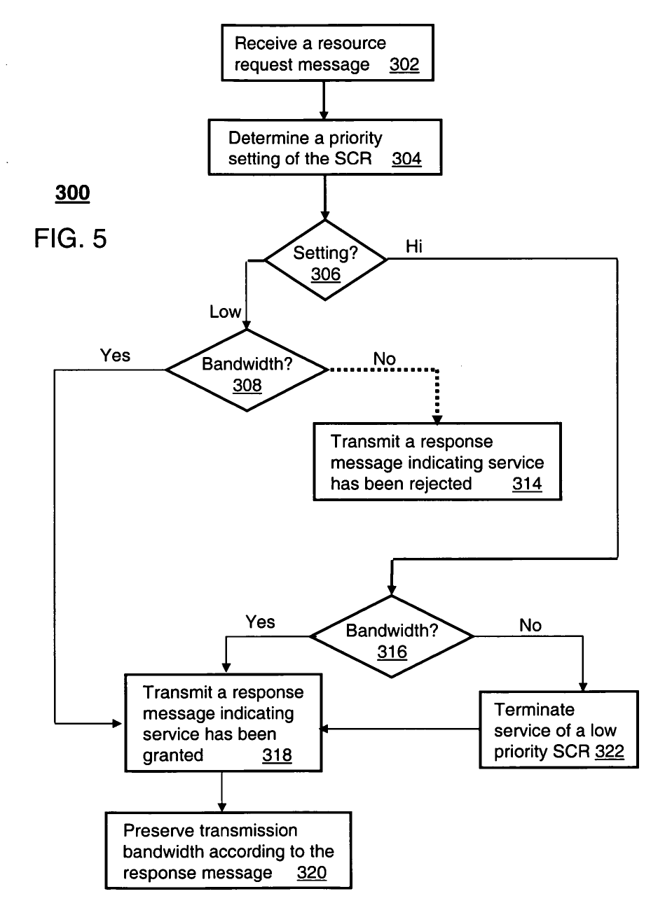

FIG. 5 is a flowchart depicting a method 300 operating in the base station 150 in accordance with an embodiment of the present invention. Method 300 begins with step 302 where the SCR 100 receives the resource request message transmitted by the SCR 100 in steps 210 or 214. In step 304, the SCR 100 determines the priority setting of the SCR 100. There are numerous ways to determine the priority level. For instance, the resource request message can include an SCR ID field identifying the SCR 100. The base station 150 in turn can search a database of SCR IDs in its storage media with associated priorities. If the priority is high at step 306, then the base station 150 proceeds to step 316 where it determines if bandwidth is available. If it is, then the base station 150 transmits in step 318 a response message to the SCR 100 indicating service has been granted with instructions on how to go about acquiring communication resources on the inbound channel. In step 320, the base station 150 preserves this bandwidth for the SCR 100 while it is actively communicating.

In cases where the base station 150 detects in step 316 that there's no available bandwidth, the base station 150 can be programmed to terminate in step 322 service on a low priority SCR 100 that had already acquired service. Depending on the urgency of the call as identified by the priority level of the SCR 100, the base station 150 can take extraordinary steps to provide the requesting SCR 100 access on the inbound channel.

If the priority setting detected in step 306 is of a low priority (which is the case for most SCRs 100), the base station 150 proceeds to step 308 where it checks for available bandwidth on the inbound channel. If there's no available bandwidth (such as might be the case in extreme traffic conditions), the base station 150 can proceed to step 314 where it transmits a response message indicating the request has been rejected. Alternatively, the base station 150 can simply just not respond (as represented by the dashed line. If bandwidth is available, the base station 150 proceeds to steps 318 and 320 performing the functions described earlier.

It should be evident to the reader that the embodiments in accordance with the present invention can be realized in hardware, software, or a combination of hardware and software. Thus, the embodiments can be embedded in a computer program product, which comprises all the features enabling the implementation of the methods described herein, and which when loaded in a computer system is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form.

It should be also evident that the embodiments in accordance with the present invention may be used in many arrangements. Thus, although the description is made for particular arrangements and methods, the intent and concepts herein are suitable and applicable to other arrangements not described herein. It would be clear therefore to those skilled in the art that modifications to the disclosed embodiments described can be effected without departing from the spirit and scope of the invention.

Accordingly, the described embodiments ought to be construed to be merely illustrative of some of the more prominent features and applications of the embodiments of the present invention. It should also be understood that the claims are intended to cover the structures described herein as performing the recited function and not only structural equivalents. Therefore, equivalent structures that read on the description are to be construed to be inclusive of the scope as defined in the following claims. Thus, reference should be made to the following claims, rather than to the foregoing specification, as indicating the scope of the embodiments of the present invention.

What is claimed is:

1. A selective call radio (SCR) for exchanging messages with a base station on inbound and outbound channels, comprising:
a wireless transceiver; and
a processor, wherein the processor is programmed to:
determine a priority setting for the SCR; and
upon detecting an appropriate priority setting, transmit a resource request message to the base station on a select one of one or more unused transmission slots associated with a transmission on the outbound channel of control information by the base station.

2. The SCR of claim 1, wherein the resource request message is a request for service, and wherein the processor is programmed to receive a response message from the base station indicating whether service has been provided.

3. The SCR of claim 2, wherein the processor is programmed to receive the response message in one among a common control channel, a intermixed control channel, or traffic channel.

4. The SCR of claim 2, wherein the processor is programmed to transmit one or more messages on the inbound channel according to instructions provided in the response message.

5. The SCR of claim 1, comprising a random generator, wherein the processor is programmed to select one of the one or more unused transmission slots for transmitting the message according to a random selection provided by the random generator.

6. The SCR of claim 1, wherein the resource request message is among one of a group comprising a request for voice service, and a request for data service.

7. The SCR of claim 1, wherein the resource request message comprises an SCR ID field and a message type field.

8. The SCR of claim 1, wherein the one or more unused transmission slots are one or more adjacent time slots corresponding to the time the control information is transmitted by the base station on the outbound channel.

9. In a selective call radio (SCR) for exchanging messages with a base station on inbound and outbound channels, a method comprising the steps of:
determining a priority setting for the SCR; and
upon detecting an appropriate priority setting, transmitting a resource request message to the base station on a select one of one or more unused transmission slots near in time to a transmission on the outbound channel of control information by the base station.

10. The method of claim 9, wherein the resource request message is a request for service, and wherein the method comprises the step of receiving a response message from the base station indicating whether service has been provided.

11. The method of claim 10, comprising the step of receiving the response message in one among a common control channel, a intermixed control channel, and a traffic channel.

12. The method of claim 10, comprising the step of transmitting one or more messages on the inbound channel according to instructions provided in the response message.

13. The method of claim 9, comprising the step of selecting one of the one or more unused transmission slots for transmitting the message according to a random selection.

14. The method of claim 9, wherein the resource request message is among one of a group comprising a request for voice service, and a request for data service.

15. The method of claim 9, wherein the resource request message comprises an SCR ID field and a message type field.

16. The method of claim 9, wherein the one or more unused transmission slots are one or more adjacent time slots corresponding to the time the control information is transmitted by the base station on the outbound channel.

17. A base station for exchanging messages with an SCR on inbound and outbound channels, comprising:
a wireless transceiver; and
a processor, wherein the processor is programmed to:
receive a resource request message from an SCR in one or more unused transmission slots in the inbound channel near in time to a transmission on the outbound channel of control information supplied by the base station;
determine a priority setting from the resource request message; and
upon detecting an appropriate priority setting, transmit a response message to the SCR indicating that service is provided.

18. The base station of claim 17, wherein the processor is programmed to transmit the response message in one among a common control channel, a intermixed control channel, and a traffic channel.

19. The base station of claim 17, wherein the processor is programmed to preserve transmission bandwidth on the inbound channel according to instructions provided in the response message.

20. The base station of claim 17, wherein the processor is programmed to terminate service of an SCR with a low priority if there is no available bandwidth on the inbound channel.
